(19) United States
(12) Patent Application Publication
(10) Pub. No.: US 2026/0197175 A1
(43) Pub. Date: Jul. 9, 2026

(54) DOUBLE-BLIND IDENTITY AUTHENTICATION METHOD AND TERMINAL AND COMPUTER-READABLE STORAGE MEDIUM

(71) Applicant: Fujian TQ Online Interactive Inc., Fuzhou (CN)

(72) Inventors: Dejian LIU, Fuzhou (CN); Zhenhua FANG, Fuzhou (CN); Liangde ZHONG, Fuzhou (CN); Weng si LAM, Fuzhou (CN); Hong CHEN, Fuzhou (CN)

(73) Assignee: Fujian TQ Online Interactive Inc., Fuzhou (CN)

(21) Appl. No.: 19/312,033

(22) Filed: Aug. 27, 2025

(30) Foreign Application Priority Data
Jan. 9, 2025 (CN) 202510032789.7

(51) Int. Cl. H04L 9/32; G06V 40/16

(52) U.S. Cl. CPC H04L 9/3231; G06V 40/168; G06V 40/172; H04L 9/3236

(57) ABSTRACT

This application provides a double-blind identity authentication method and terminal and a computer-readable storage medium. The method includes: Acquiring a first facial feature vector uniquely identifying a user during user registration, and encrypting the first facial feature vector according to a preset encryption algorithm to obtain a first encrypted feature vector; acquiring a current second facial feature vector of the user during identity authentication, and encrypting the current second facial feature vector according to the preset encryption algorithm to obtain a second encrypted feature vector to be verified; and matching the second encrypted feature vector with the first encrypted feature vector, and if the matching is successful, displaying that the identity authentication succeeds. This application provides a safe and reliable identity authentication function to eliminate the risks of identity forgery and privacy breaches.

### CROSS-REFERENCE TO RELATED APPLICATIONS

This application claims priority to Chinese Patent Application No. 202510032789.7, filed on Jan. 9, 2025, which is incorporated herein by reference in its entirety.

### TECHNICAL FIELD

This application relates to the technical field of identity authentication, and in particular, to a double-blind identity authentication method and terminal and a computer-readable storage medium.

### BACKGROUND

With the emergence of online education, telecommuting, and other digital services, the security, privacy, and reliability of identity authentication have become key issues. Traditional identity authentication methods include user name and password combinations, SMS verification codes and the like, and further include biological recognition technologies, such as facial recognition and fingerprint identification.

Especially in some online education and examination scenarios, an existing identity authentication system usually stores real identity information or biological data of a user.

### SUMMARY

The technical solution adopted in this application is as follows.

A double-blind identity authentication method includes the following steps: acquiring a first facial feature vector uniquely identifying a user during user registration, and encrypting the first facial feature vector according to a preset encryption algorithm to obtain a first encrypted feature vector; acquiring a current second facial feature vector of the user during identity authentication, and encrypting the current second facial feature vector according to the preset encryption algorithm to obtain a second encrypted feature vector to be verified; and matching the second encrypted feature vector with the first encrypted feature vector, and displaying that the identity authentication succeeds if the matching is successful.

Another technical solution adopted in this application is: a double-blind identity authentication terminal, including a memory, a processor, and a computer program stored in the memory and executable on the processor, where the processor, when executing the computer program, performs the double-blind identity authentication method described above.

Another technical solution adopted in this application is: a computer-readable storage medium, storing a computer program, where the computer program, when executed by a processor, implements the steps of the double-blind identity authentication method described above.

### BRIEF DESCRIPTION OF THE DRAWINGS

FIG. 1 is a schematic diagram illustrating steps of a double-blind identity authentication method according to this application;

FIG. 2 is a system block diagram of a double-blind identity authentication terminal according to this application; and

FIG. 3 is a schematic diagram illustrating a computer-readable storage medium according to this application.

### DETAILED DESCRIPTION OF THE EMBODIMENTS

To provide a detailed explanation of technical content, objectives and effects of this application, the following description is given with reference to embodiments and the accompanying drawings.

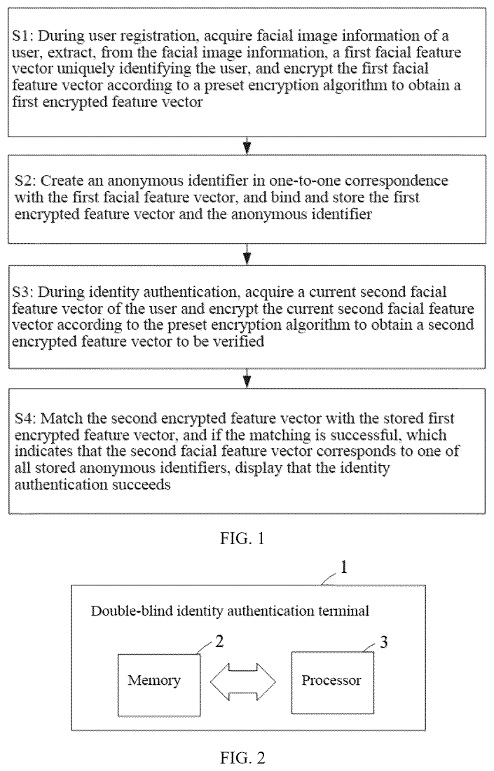

Referring to FIG. 1, a double-blind identity authentication method includes the following steps:
S1: acquiring facial image information of a user during user registration, extracting, from the facial image information, a first facial feature vector uniquely identifying the user, and encrypting the first facial feature vector according to a preset encryption algorithm to obtain a first encrypted feature vector;
S2: creating an anonymous identifier in one-to-one correspondence with the first facial feature vector, and binding and storing the first encrypted feature vector and the anonymous identifier;
S3: acquiring a current second facial feature vector of the user during identity authentication, and encrypting the current second facial feature vector according to the preset encryption algorithm to obtain a second encrypted feature vector to be verified; and
S4: matching the second encrypted feature vector to be verified with the stored first encrypted feature vector, and if the matching is successful, which indicates that the current second facial feature vector of the user corresponds to one of all stored anonymous identifiers, displaying that the identity authentication succeeds.

It can be learned from the above descriptions that the beneficial effects of this application lie in that: during user registration, the first facial feature vector uniquely identifying the user is extracted from the facial image information of the user, and then is encrypted to obtain the first encrypted feature vector, which is subsequently bound and stored with the anonymous identifier considered as personal information of the user. The user does not need to input their name or any other identity information. During identity authentication, the user only needs to provide facial information. This is converted into the second encrypted feature vector to be verified, which is then matched with the stored first encrypted feature vector. If the matching is successful, it indicates that the current second facial feature vector of the user corresponds to one of all stored anonymous identifiers and the identity authentication succeeds. In this way, even if an identity authentication system is subjected to an external attack, an intruder can only acquire the first encrypted feature vector and the bound anonymous identifier, and cannot determine which user the encrypted feature vector belongs to, the system itself cannot associate the first encrypted feature vector and the anonymous identifier with a specific user, and the user does not need to know their own anonymous identifier, achieving double-blind protection, eliminating the risks of identity forgery and privacy breaches, and making an identity authentication function safer and more reliable.

Further, step S2 specifically includes:
generating the unique anonymous identifier according to the preset random algorithm, binding the first encrypted feature vector and the anonymous identifier, and storing the first encrypted feature vector and the anonymous identifier in a blockchain.

It can be learned from the above descriptions that generating the anonymous identifier using an irregular preset random algorithm reduces the possibility of backtracking an identity of the user from the anonymous identifier. At the same time, storing the data in the blockchain ensures the immutability and traceability of the data. Even in a distributed environment, an authentication result can also be verified by a third-party organization.

Further, after step S4, the method further includes:
S5: integrating the second encrypted feature vector of the user undergoing the identity authentication, authentication time, and an authentication result into an authentication record, and binding the authentication record with other operation data generated after the user completes the identity authentication.

It can be learned from the above descriptions that the authentication record serves as a credential bound to the other operation data of the user. In some scenarios, the authentication record can be used to verify the validity of other data such as a learning or examination result in a learning or examination system.

Further, after step S4, the method further includes:
S6: when the user performs the other operations after completing the identity authentication, generating an interactive task and waiting to acquire a task completion result of the user, and terminating the other operations of the user if the user fails to complete the interactive task.

It can be learned from the above descriptions that for some systems requiring long-term operation, especially for some learning systems, the interactive task can be generated to verify the ongoing presence of the user when the user performs the other operations after completing the identity authentication, helping urge the user to study more diligently.

Further, after step S4, the method further includes:
starting from time when the user completes the identity authentication, and regenerating an identity authentication request for the user after a preset duration.

It can be learned from the above descriptions that by performing the identity authentication for a plurality of times, the method continuously verifies that the current user is a user who has passed the identity authentication, thereby achieving the effect of preventing cheating, and eliminating cheating behaviours such as impersonation in learning or examination scenarios.

Further, the method further includes:
after the user completes initial identity authentication, collecting facial information of the user at a preset frequency, extracting a new second facial feature vector from the facial information, and encrypting the new second facial feature vector according to the preset encryption algorithm; and
matching the new second facial feature vector with the first encrypted feature vector extracted during user registration, and continuing to authorize the user to perform other operations if the matching is successful, otherwise terminating the other operations of the user.

It can be learned from the above descriptions that when the user completes the initial identity authentication operation and continues to perform the other operations on the system, the facial information of the user is collected at the preset frequency, the new second facial feature vector is extracted, and the identity authentication operation is performed again. This process is repeated to ensure that a person performing the subsequent operations on the system should be the user who completed the initial identity authentication. If the user leaves the system or is replaced by another person midway, an instruction to terminate the operation will be triggered. This improves the real-time presence verification of the system, particularly in a long-time usage scenario such as online learning, and prevents behaviours such as “leaving the system while logged in” or “operating on behalf of others”.

Referring to FIG. 2, a double-blind identity authentication terminal 1 includes a memory 2, a processor 3, and a computer program stored in the memory 2 and executable on the processor 3, where the processor 3, when executing the computer program, implements the following steps:
S1: acquiring facial image information of a user during user registration, extracting, from the facial image information, a first facial feature vector uniquely identifying the user, and encrypting the first facial feature vector according to a preset encryption algorithm to obtain a first encrypted feature vector;
S2: creating an anonymous identifier in one-to-one correspondence with the first facial feature vector, and binding and storing the first encrypted feature vector and the anonymous identifier;
S3: acquiring a current second facial feature vector of the user during identity authentication, and encrypting the current second facial feature vector according to the preset encryption algorithm to obtain a second encrypted feature vector to be verified; and
S4: matching the second encrypted feature vector to be verified with the stored first encrypted feature vector, and if the matching is successful, which indicates that the current second facial feature vector of the user corresponds to one of all stored anonymous identifiers, displaying that the identity authentication succeeds.

It can be learned from the above descriptions that the beneficial effects of this application lie in that: during user registration, the first facial feature vector uniquely identifying the user is extracted from the facial image information of the user, and is then encrypted to obtain the first encrypted feature vector, which is subsequently bound and stored with the anonymous identifier considered as personal information of the user. The user does not need to input their name or any other identity information. During identity authentication, the user only needs to provide facial information. This is converted into the second encrypted feature vector to be verified, which is then matched with the stored first encrypted feature vector. If the matching is successful, it indicates that the current second facial feature vector of the user corresponds to one of all stored anonymous identifiers and the identity authentication succeeds. In this way, even if an identity authentication system is subjected to an external attack, an intruder can only acquire the first encrypted feature vector and the bound anonymous identifier, and cannot determine which user the encrypted feature vector belongs to, the system itself cannot associate the first encrypted feature vector and the anonymous identifier with a specific user, and the user does not need to know their own anonymous identifier achieving double-blind protection, eliminating the risks of identity forgery and privacy breaches, and making an identity authentication function safer and more reliable.

Further, step S2 specifically includes:
generating the unique anonymous identifier according to the preset random algorithm, binding the first encrypted feature vector and the anonymous identifier, and storing the first encrypted feature vector and the anonymous identifier in a blockchain.

It can be learned from the above descriptions that generating the anonymous identifier using an irregular preset random algorithm reduces the possibility of backtracking an identity of the user from the anonymous identifier. At the same time, storing the data in the blockchain ensures the immutability and traceability of the data. Even in a distributed environment, an authentication result can also be verified by a third-party organization.

Further, after step S4, the method further includes:
S5: integrating the second encrypted feature vector of the user undergoing the identity authentication, authentication time, and an authentication result into an authentication record, and binding the authentication record with other operation data after the user completes the identity authentication.

It can be learned from the above descriptions that the authentication record serves as a credential bound to the other operation data of the user. In some scenarios, the authentication Substitute Specification Clean record can be used to verify the validity of other data such as a learning or examination result in a learning or examination system.

Further, after step s4, the method further includes:
S6: when the user performs the other operations after completing the identity authentication, generating an interactive task and waiting to acquire a task completion result of the user, and terminating the other operations of the user if the user fails to complete the interactive task.

It can be learned from the above descriptions that for some systems requiring long-term operation, especially for some learning systems, the interactive task can ge generated to verify the ongoing presence of the user when the user performs the other operations after completing the identity authentication, helping urge the user to study more diligently.

Further, after step S4, the method further includes:
starting from time when the user completes the identity authentication, and regenerating an identity authentication request for the user after a preset duration.

It can be learned from the above descriptions that by performing the identity authentication for a plurality of times, the method continuously verifies that the current user is a user who has passed the identity authentication, thereby achieving the effect of preventing cheating, and eliminating cheating behaviours such as impersonation in learning or examination scenarios.

Further, the method further includes:
after the user completes initial identity authentication, collecting facial information of the user at a preset frequency, extracting a new second facial feature vector from the facial information, and encrypting the new second facial feature vector according to the preset encryption algorithm; and
matching the new second facial feature vector with the first encrypted feature vector extracted during user registration, and continuing to authorize the user to perform other operations if the matching is successful, otherwise terminating the other operations of the user.

It can be learned from the above descriptions that when the user completes the initial identity authentication operation and continues to perform the other operations on the system, the facial information of the user is collected at the preset frequency, the new second facial feature vector is extracted, and the identity authentication operation is performed again. This process is repeated to ensure that a person performing the subsequent operations on the system should be the user who completed the initial identity authentication. If the user leaves the system or is replaced by another person midway, an instruction to terminate the operation will be triggered. This improves the real-time presence verification of the system, particularly in a long-time usage scenario such as online learning, and prevents behaviours such as “leaving the system while logged in” or “operating on behalf of others”.

In related technologies, traditional methods are prone to the risks of attacks, identity forgery, and privacy breaches. Although the biological recognition technologies improve the accuracy of identity authentication, biological data of the user is often directly stored, leading to a potential risk of privacy breaches. In addition, in some online education and examination scenarios, this can lead to privacy breaches and increases the likelihood of cheating behaviours such as impersonation in learning or examination. This application provides a double-blind identity authentication method and terminal and a computer-readable storage medium, offering a safe and reliable identity authentication function to eliminate the risks of identity forgery and privacy breaches.

Referring to FIG. 1, a double-blind identity authentication method is illustrated, which specifically has the following double-blind features:
user-level blindness: the user does not need to know their own anonymous identifier (ID) or a specific storage manner of the first encrypted feature vector during identity authentication, and only needs to input the current facial image information through a camera to complete the identity authentication.
system-level blindness: the system cannot know the real identity of the user during identity authentication and can only determine legitimacy based on the binding relationship between the currently input first encrypted facial feature vector and the anonymous identifier (ID).

Therefore, the method includes the following steps:
S1: acquiring facial image information of a user during user registration, extracting from the facial image information, a first facial feature vector uniquely identifying the user, and encrypting the first facial feature vector according to a preset encryption algorithm to obtain a first encrypted feature vector.

During registration, the user does not need to actively input real identity information such as their name or an ID card number, and only needs to enter their facial image information, The system internally encrypts the first facial feature vector according to the preset encryption algorithm. Specifically, the facial feature vector is encrypted using a hash function (such as SHA-256) or a symmetric encryption algorithm (such as AES), and the encrypted feature vector cannot be reversed back into the original facial data.
S2: creating an anonymous identifier in one-to-one correspondence with the first facial feature vector, and binding and storing the first encrypted feature vector and the anonymous identifier.

In an embodiment of this application, the unique anonymous identifier is generated using the preset random algorithm. The anonymous identifier, considered as personal information of the user, is bound with the first encrypted feature vector, and both are stored in a blockchain. The anonymous identifier does not contain any content related to the specific identity information of the user, but only serves as an identifier ID.
S3: acquiring a current second facial feature vector of the user during identity authentication, and encrypting the current second facial feature vector according to the preset encryption algorithm to obtain a second encrypted feature vector to be verified.
S4: matching the second encrypted feature vector to be verified with the stored first encrypted feature vector, and if the matching is successful, which indicates that the current second facial feature vector of the user corresponds to one of all stored anonymous identifiers, displaying that the identity authentication succeeds, or determining, by the system, that the user is an unauthorized user and authentication fails if no matching relationship exists.

In an embodiment of this application, the double-blind identity authentication method is applied to an online learning operating system. After the user completes the initial identity authentication, the online learning operating system continuously collects the facial image information of the user at the preset frequency, extracts the second facial feature vector, encrypts the second facial feature vector, and then matches the second encrypted feature vector with the first encrypted feature vector during registration. The system continues to allow the user to operate if the matching is successful, or the system suspends or terminates the current operation if the matching is failure or an image is missing.

In an embodiment of this application, the matching process may optionally use Euclidean distance or cosine similarity to calculate the similarity between the encrypted feature vectors. In addition, a matching threshold is determined through experimentation. For example, if the similarity is greater than 0.95, a successful matching is determined so as to balance accuracy and fault tolerance of authentication.
S5: integrating the second encrypted feature vector of the user undergoing authentication, authentication time, and an authentication result into an authentication record, and binding the authentication record with other operation data after the user completes the identity authentication.

In an embodiment of this application, taking an examination or learning result an example, after completing the identity authentication, the user performs relevant operations such as taking an examination or learning on the system, and then, an administrator can query through the authentication record to verify the consistency between the outcome and the identity of the user when required to query the examination or learning result of the user.
S6: when the user performs other operations after completing the identity authentication, generating an interactive task and waiting to acquire a task completion result of the user, and terminating the other operations of the user if the user fails to complete the interactive task.

In an embodiment of this application, the interactive task may be actions such as answering a question, or clicking a button, and can be combined with a facial recognition result to verify the identity authenticity of the user. In addition, starting from time when the user completes the identity authentication, and an identity authentication request is regenerated for the user after the preset duration. An active form is preferably used for the identity authentication. A facial recognition operation is triggered every preset duration, the encrypted feature vector of the user is extracted and verified, and a plurality of authentication nodes are generated. The preset duration may be set to 30 seconds or 1 minute.

In other equivalent embodiments, the facial recognition operation triggered every preset duration during identity authentication may be replaced with high-frequency facial recognition capturing. For example, the facial information of the user is automatically collected every 5 to 10 seconds, a new second facial feature vector is extracted from the facial information and is encrypted according to the preset encryption algorithm, the new second facial feature vector is matched with the first encrypted feature vector extracted during user registration, the user is allowed to continue other operations if the matching is successful, otherwise the other operations of the user are terminated.

To summarize the above steps, it is worth noting that the double-blind identity authentication method of this application is applicable to a scenario such as online learning or examinations, where the user is required to remain present throughout the session. After the user completes initial identity authentication, the system may continuously capture facial images of the user at a set high frequency (preferably every 5 to 10 seconds) through the camera, extract the second facial feature vector, and encrypt the second facial feature vector into the second encrypted feature vector according to the original encryption algorithm. The system matches, in real time, the vector with the first encrypted feature vector stored during registration. If the matching is successful, the system continues to allow the operation of the user. If the matching fails, or a valid facial image cannot be acquired within a specified time, the system may automatically suspend the current operation, issue a prompt, or require identity authentication again, which ensures the identity consistency of an operator. This technology improves the real-time presence verification of the system in a long-time usage scenario, prevents behaviours such as “leaving the system while logged in” or “operating on behalf of others”, and further ensures authenticity and security of the system.

Referring to FIG. 2, a double-blind identity authentication terminal 1 includes a memory 2, a processor 3, and a computer program stored in the memory 2 and executable on the processor 3, where the processor 3, when executing the computer program, implements the double-blind identity authentication method.

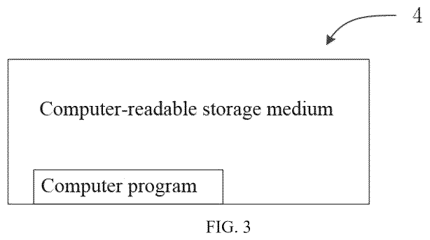

Referring to FIG. 3, a computer-readable storage medium 4, storing a computer program, where the computer program, when executed by a processor, implements each step of the double-blind identity authentication method described above.

In summary, this application provides a double-blind identity authentication method and terminal and a computer-readable storage medium, which are applicable in various scenarios such as online education, remote examination, and e-government affairs. During user registration, the first facial feature vector uniquely identifying the user is extracted from the facial image information of the user, and is then encrypted to obtain the first encrypted feature vector, which is subsequently bound and stored with the anonymous identifier considered as personal information of the user. The user does not need to input their name or any other identity information. During identity authentication, the user only needs to provide facial information. This is converted into the second encrypted feature vector to be verified, which is then matched with the stored first encrypted feature vector. If the matching is successful, it indicates that the current second facial feature vector of the user corresponds to one of all stored anonymous identifiers and the identity authentication succeeds. In this way, even if an identity authentication system is subjected to an external attack, an intruder can only acquire the first encrypted feature vector and the bound anonymous identifier, and cannot determine which user the encrypted feature vector belongs to, the system itself cannot associate the first encrypted feature vector and the anonymous identifier with a specific user, and the user does not need to know their anonymous identifier, achieving double-blind protection, eliminating the risks of identity forgery and privacy breaches, and making an identity authentication function safer and more reliable.

The above descriptions are only embodiments of this application, and are not intended to limit the scope of this application. Any equivalent transformations made based on contents of this specification and the accompanying drawings of this application, or direct or indirect applications in the related technical field shall fall within the protection scope of this application.

What is claimed is:

1. A double-blind identity authentication method, comprising the following steps:
acquiring a first facial feature vector uniquely identifying a user during user registration, and encrypting the first facial feature vector according to a preset encryption algorithm to obtain a first encrypted feature vector;
acquiring a current second facial feature vector of the user during identity authentication, and encrypting the current second facial feature vector according to the preset encryption algorithm to obtain a second encrypted feature vector to be verified; and
matching the second encrypted feature vector with the first encrypted feature vector, and if the matching is successful, displaying that the identity authentication succeeds.

2. The double-blind identity authentication method according to claim 1, wherein after the encrypting the first facial feature vector according to the preset encryption algorithm to obtain the first encrypted feature vector, the method comprises:
creating an anonymous identifier in one-to-one correspondence with the first facial feature vector, and binding and storing the first encrypted feature vector and the anonymous identifier.

3. The double-blind identity authentication method according to claim 2, wherein creating the anonymous identifier in one-to-one correspondence with the first facial feature vector and binding and storing the first encrypted feature vector and the anonymous identifier comprises:
generating the unique anonymous identifier according to a preset random algorithm, binding the first encrypted feature vector and the anonymous identifier, and storing the first encrypted feature vector and the anonymous identifier in a blockchain.

4. The double-blind identity authentication method according to claim 1, wherein acquiring the first facial feature vector uniquely identifying the user during user registration comprises:
acquiring facial image information of the user during user registration, and extracting, from the facial image information, the first facial feature vector uniquely identifying the user.

5. The double-blind identity authentication method according to claim 1, wherein matching the second encrypted feature vector with the first encrypted feature vector comprises:
matching the second encrypted feature vector with the first encrypted feature vector, wherein if the matching is successful, it indicates that the second facial feature vector corresponds to one of all stored anonymous identifiers.

6. The double-blind identity authentication method according to claim 1, wherein after the matching the second encrypted feature vector with the first encrypted feature vector, and if the matching is successful, displaying that the identity authentication succeeds, the method further comprises:
integrating the second encrypted feature vector of the user undergoing the identity authentication, authentication time, and an authentication result into an authentication record, and binding the authentication record with other operation data generated after the user completes the identity authentication.

7. The double-blind identity authentication method according to claim 6, wherein after the integrating the second encrypted feature vector of the user undergoing the identity authentication, the authentication time, and the authentication result into the authentication record, and binding the authentication record with the other operation data after the user completes the identity authentication, the method further comprises:
when the user performs other operations after completing the identity authentication, generating an interactive task and waiting to acquire a task completion result of the user, and terminating the other operations of the user if the user fails to complete the interactive task.

8. The double-blind identity authentication method according to claim 7, wherein the interactive task comprises answering a question and clicking a button.

9. The double-blind identity authentication method according to claim 1, wherein after the matching the second encrypted feature vector with the first encrypted feature vector, and displaying that the identity authentication succeeds if the matching is successful, the method further comprises:
starting from time when the user completes the identity authentication, and regenerating an identity authentication request for the user after a preset duration.

10. The double-blind identity authentication method according to claim 9, wherein regenerating the identity authentication request for the user after the preset duration comprises:
regenerating a facial recognition operation request for the user after the preset duration.

11. The double-blind identity authentication method according to claim 1, further comprising:
after the user completes initial identity authentication, collecting facial information of the user at a preset frequency, extracting a new second facial feature vector from the facial information, and encrypting the new second facial feature vector according to the preset encryption algorithm; and
matching the new second facial feature vector with the first encrypted feature vector extracted during user registration, continuing to authorize the user to perform other operations if the matching is successful, otherwise terminating the other operations of the user.

12. The double-blind identity authentication method according to claim 11, wherein the preset frequency is higher than a high frequency threshold.

13. The double-blind identity authentication method according to claim 11, wherein collecting the facial information of the user at the preset frequency comprises:
collecting the facial information of the user every 5 to 10 seconds.

14. The double-blind identity authentication method according to claim 1, wherein encrypting the first facial feature vector according to the preset encryption algorithm to obtain the first encrypted feature vector comprises:
encrypting the first facial feature vector based on a hash function to obtain the first encrypted feature vector.

15. The double-blind identity authentication method according to claim 1, wherein encrypting the first facial feature vector according to the preset encryption algorithm to obtain the first encrypted feature vector comprises:
encrypting the first facial feature vector based on a symmetric encryption algorithm to obtain the first encrypted feature vector.

16. The double-blind identity authentication method according to claim 1, wherein matching the second encrypted feature vector with the first encrypted feature vector comprises:
if no matching relationship exits, determining, by a system, that the user is an unauthorized user and authentication fails.

17. The double-blind identity authentication method according to claim 1, wherein matching the second encrypted feature vector with the first encrypted feature vector comprises:
calculating a similarity between the second encrypted feature vector and the first encrypted feature vector according to a Euclidean distance, and determining a successful match if the similarity exceeds a matching threshold.

18. The double-blind identity authentication method according to claim 1, wherein matching the second encrypted feature vector with the first encrypted feature vector comprises:
calculating a similarity between the second encrypted feature vector and the first encrypted feature vector according to a cosine similarity, and determining a successful match if the similarity exceeds a matching threshold.

19. A double-blind identity authentication terminal, comprising a memory, a processor, and a computer program stored in the memory and executable on the processor, wherein the processor, when executing the computer program, performs steps of the double-blind identity authentication method according to claim 1.

20. A computer-readable storage medium, storing a computer program, wherein the computer program, when executed by a processor, implements steps of the double-blind identity authentication method according to claim 1.
